(19) United States
(12) Patent Application Publication
(10) Pub. No.: US 2009/0211860 A1
(43) Pub. Date: Aug. 27, 2009

(54) WIRE AND CABLE ORGANIZING SYSTEM

(76) Inventor: Jonathan P. Glenn, Los Angeles, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/350,163

(22) Filed: Jan. 7, 2009

Related U.S. Application Data
(60) Provisional application No. 61/007,536, filed on Feb. 22, 2008.

(51) Int. Cl. H02G 11/02; B65H 75/44

(52) U.S. Cl. 191/12.2 R

(57) ABSTRACT

A simple and effective wire and cable management device includes a housing generally in the form of a rectangular cuboid having opposing front and back walls, opposing top and bottom walls and opposing first and second side walls. A reel is disposed within the housing and is rotatable on an axis perpendicular to the front and back walls. A peripheral portion of the reel extends through an opening in the side wall of the housing. At least two of the opposing walls have cooperating mechanical couplings for securing the device to another identical device so that a plurality of devices may be easily connected together to manage and organize an array of wires, cables and cords.

### BACKGROUND OF THE INVENTION

1. Field of the Invention

This invention relates to devices for organizing and managing wires, cables and cords.

2. Background

A number of cable management devices have been devised for organizing a single wire, cable or cord. However, such devices are not designed to organize a cluster of cables at the same time. Traditionally, groups of wires are tied together by either a plastic or Velcro wire-tie. As easy as it may be to tie wires together with plastic ties or Velcro, organizing bundles of wire is much more difficult. There is no uniform solution to labeling wires. Furthermore, when it is necessary to disconnect the wires, traditionally bundled wires are cumbersome to disassemble. Should one wish to unbundle a collection of wires, they can become tangled and hard to organize. Organizing such cable spaghetti or cable clutter is a persistent need in our technological society.

### SUMMARY OF THE INVENTION

The present invention provides a wire and cable organizing system in the form of a set of plastic boxes that connect together in different ways to bundle loose wires together. The individual wires may be identified with labels and color coding. The boxes can be easily disconnected from each other allowing easy identification, removal and reattachment of a wire to the bundle. Each box may be approximately eight centimeters tall, eight centimeters wide and three centimeters in depth, which will hold an average consumer wire such as a USB cable or RCA set of cables for a television. By wrapping each cable into a specific color coded and labeled box, the user can easily bundle loose wires together and unbundle them when necessary. The system replaces conventional disposable wire ties or Velcro straps. The boxes snap together either front-to-back or side-to-side as described in, which allows flexibility in hiding wires behind a narrow or wide space.

More specifically, the present invention provides a simple and effective wire and cable management system comprising a housing generally in the form of a rectangular cuboid having opposing front and back walls, opposing top and bottom walls and opposing first and second side walls. A reel is disposed within the housing and is rotatable on an axis perpendicular to the front and back walls. A peripheral portion of the reel extends through an opening in the side wall of the housing. At least two of the opposing walls have cooperating mechanical couplings for securing the device to another identical device so that a plurality of devices may be easily connected together to manage and organize an array of wires, cables and cords.

### BRIEF DESCRIPTION OF THE DRAWINGS

FIG. 1 is a perspective view of a cable management device constructed in accordance with an embodiment of the present invention.

FIG. 2 is an elevation view showing the back side of the device shown in FIG. 1.

FIG. 3 illustrates the device in an open configuration.

FIG. 4 shows a plurality of cable management devices attached to one another.

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

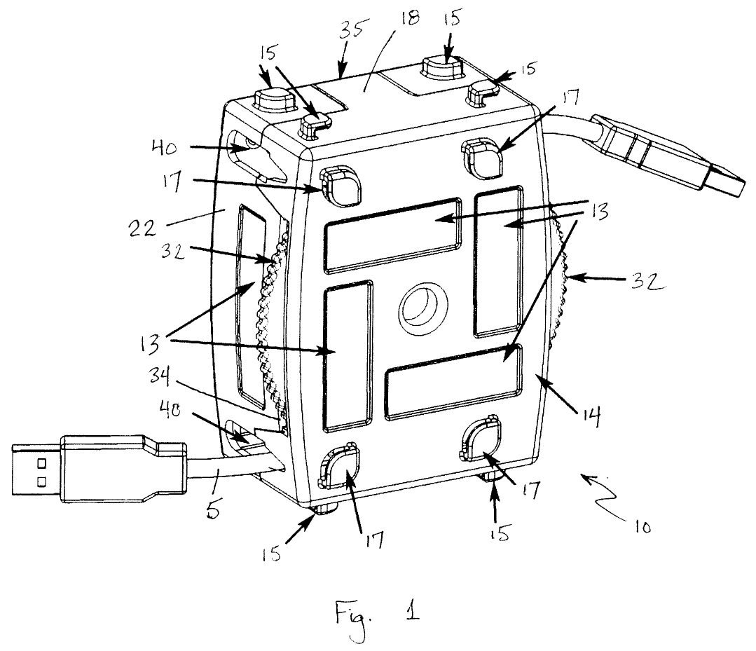

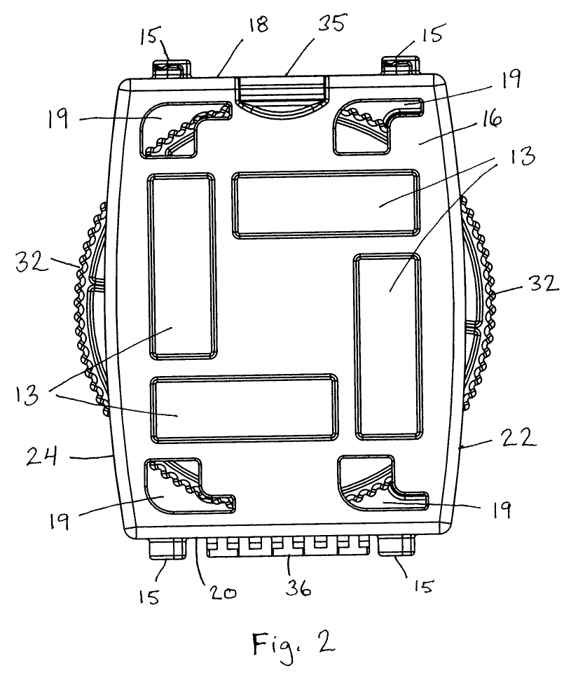

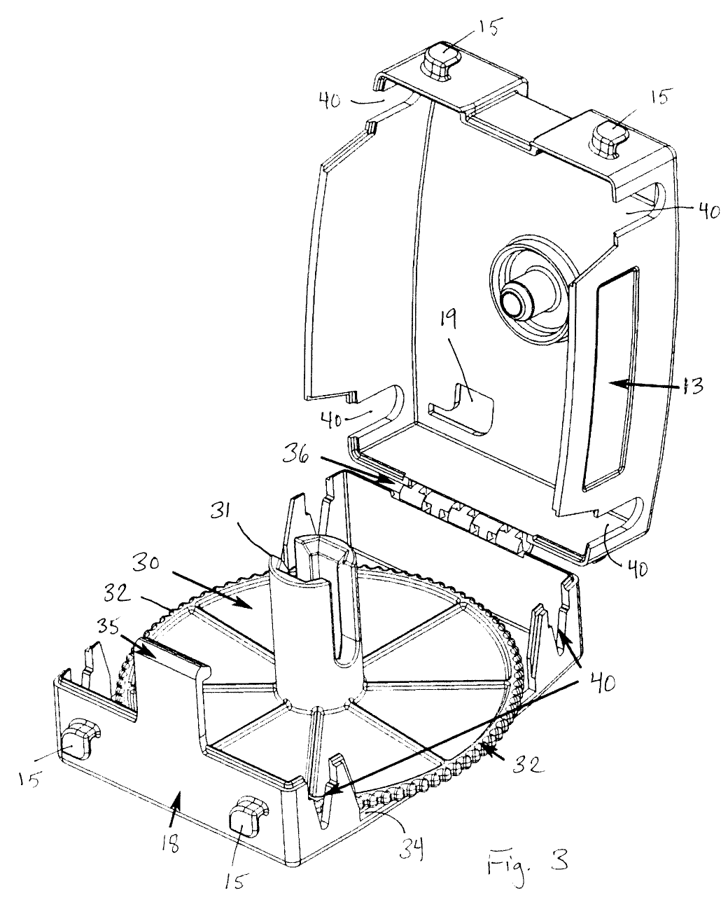

Referring to FIGS. 1-3, a cable management device 10 in accordance with an embodiment of the present invention is shown. A housing 12 has the general form of a rectangular cuboid with front wall 14, back wall 16, top wall 18, bottom wall 20 and side walls 22 and 24. The walls of housing 12 may be embossed with recesses 13 for receiving identification labels. Top wall 18 and bottom wall 20 have interlocking connecting clips 15. Front wall 14 has male connecting clips 17 that mate with female connecting apertures 19 on back wall 16.

Spool 30 is rotatably mounted within housing 12. Peripheral portions 32 of the spool protrude through slots 34 in side walls 22 and 24. Access to the spool is provided by releasing clip 35 and opening housing 12 at hinge 36. With the housing in the open configuration, a cable 5 may be wound around spool hub 31. The ends of the cable exit the housing through openings 40 in side walls 22 and 24. Openings 40 may be tapered at one end so that cable 5 may be wedged into place with the desired amount of cable extending outside the housing. The peripheral portions 32 of the spool extending through slots 34 may be grasped when the housing is in a closed configuration to tighten the cable around the spool and to make fine adjustments in the length of cable extending outside the housing.

The housing 12 and spool 30 may be injection molded components, although other suitable manufacturing processes may be utilized. These components may be molded in various colors, if desired, for color coding different types of cable or merely for decorative effect.

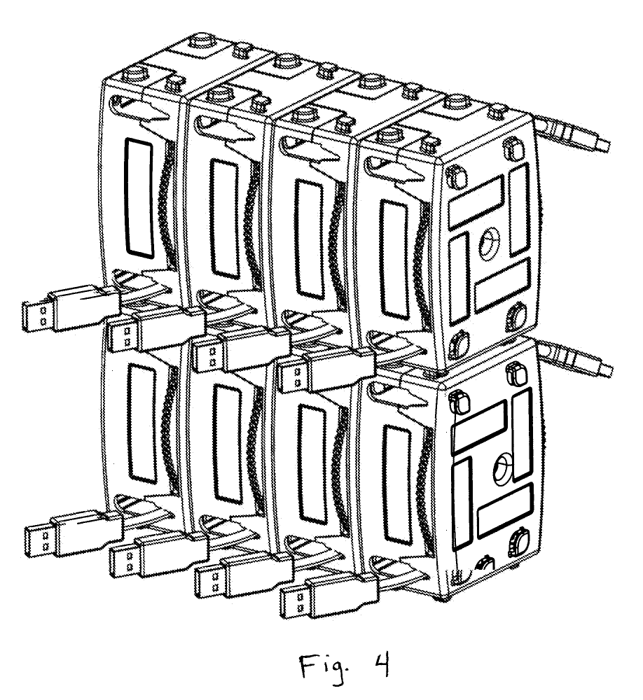

FIG. 4 shows an array of eight cable management devices 10 connected together in two tiers of four devices each. The devices within each tier are coupled together using male connecting clips 17 and female apertures 19 on the front and back walls of the devices. The top and bottom tiers are connected using interlocking connecting clips 15 on the top and bottom walls of the devices.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A cable management device comprising:
a housing generally in the form of a rectangular cuboid having opposing front and back walls, opposing top and bottom walls and opposing first and second side walls;
a reel disposed within the housing and rotatable on an axis perpendicular to the front and back walls, a peripheral portion of the reel extending through an opening in a side wall of the housing;
at least two of the opposing walls having cooperating mechanical couplings for securing the device to another identical device.

2. The cable management device of claim 1 wherein the housing includes first and second apertures for a cable to enter and exit the housing.

3. The cable management device of claim 2 wherein a portion of at least one of the first and second apertures is tapered to grippingly engage a cable passing therethrough.

4. The cable management device of claim 1 wherein the cooperating mechanical couplings comprise a male connecting clip and a female aperture.

5. The cable management device of claim 1 wherein the cooperating mechanical couplings comprise interlocking connecting clips.
